(19) United States
(12) Patent Application Publication
(10) Pub. No.: US 2010/0180011 A1
(43) Pub. Date: Jul. 15, 2010

(54) URL BASED RETRIEVAL OF PORTIONS OF MEDIA CONTENT

(75) Inventors: Vishal Sood, Bothell, WA (US); Geqiang (Sam) Zhang, Redmond, WA (US); John A. Bocharov, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/364,534

(22) Filed: Feb. 3, 2009

Related U.S. Application Data
(60) Provisional application No. 61/144,081, filed on Jan. 12, 2009.

(51) Int. Cl. G06F 15/16

(52) U.S. Cl. 709/219

(57) ABSTRACT

A media fragmenting system is described herein that allows requesting portions of a content item through information specified in a Uniform Resource Identifier (URI) used to retrieve the content item. Media fragments retrieved using the media fragmenting system are cacheable by existing Internet infrastructure and allow clients to retrieve portions of a content item without retrieving the entire content item. The media fragmenting system adds a content range segment to the URI to specify a portion of the content item. A server receiving the URI accesses the content item, identifies the requested portion, and returns the requested portion in a standard HTTP response to the client. Because no changes to the HTTP protocol are involved, intermediate servers, routers, and proxies, can all handle the request and response as well as cache the response without modification.

### CROSS-REFERENCE TO RELATED APPLICATIONS

The present application claims priority to U.S. Provisional Patent Application No. 61/144,081 (Attorney Docket No. 325951.01) entitled “URL BASED RETRIEVAL OF PORTIONS OF MEDIA CONTENT,” and filed on Jan. 12, 2009, which is hereby incorporated by reference.

### BACKGROUND

The Internet contains many types of downloadable media content items, including audio, video, documents, and so forth. These content items are often very large, such as video in the hundreds of megabytes. Users often retrieve documents over the Internet using the Hypertext Transport Protocol (HTTP) through a web browser. The Internet has built up a large infrastructure of routers and proxies that are effective at caching data for HTTP. Servers can provide cached data to clients with less delay and by using fewer resources than re-requesting the content from the original source. For example, a user in New York may download a content item served from a host in Japan, and receive the content item through a router in California. If a user in New Jersey requests the same file, the router in California may be able to provide the content item without again requesting the data from the host in Japan. This reduces the network traffic over possibly strained routes, and allows the user in New Jersey to receive the content item with less latency.

Often, a user is only interested in a portion of a large content item, such as a particular page of a large Portable Document Format (PDF) document or a particular time range in a large video. Unfortunately, the only way to get the desired portion of the content item in some cases is to download the entire content item to the user's computer and then open the content item to find the portion of interest. Even if a user could retrieve a portion of a large content item, it is desirable for the portion to be cacheable by the existing Internet infrastructure, and to be compatible with later downloading of additional portions of the same content item.

One prior attempt to solve this problem is HTTP byte ranges or byte serving. Byte serving is the process of sending only a portion of an HTTP/1.1 message from a server to a client. In the HTTP/1.0 standard, clients were only able to request an entire document. By allowing byte serving, HTTP/1.1 allows clients to choose any portion of the resource. One advantage of this capability occurs when a client requests a large media file with a proper format, as the client may be able to request just the portions of the file known to be of interest. Unfortunately, bytes have very little meaning in the context of many content items. For example, byte ranges have little relation to the page number of a PDF file or the time offset in a video without the user having advance knowledge of the layout of a particular content item of interest. The two biggest challenges with byte ranges are that they are not cacheable by all proxies and some browsers do not allow byte range requests as they involve setting special headers. Byte ranges also are difficult to use with content items that change. Providers of video and other content items often insert ads or other interstitial information that can change the length and byte layout of the content items in ways that unintentionally frustrate attempts to retrieve portions of the content items using byte ranges. In addition, many browsers and other HTTP applications do not understand byte ranges or implement HTTP/1.1.

Another solution proposed by the World Wide Web Consortium (W3C) working group on media fragments is the addition of axis ranges to HTTP. Axis ranges are similar to byte ranges, but refer to a particular domain, such as time, rather than bytes. However, such changes imply updating every client, server, and router to understand the new ranges, and thus caching could not occur with existing Internet infrastructure. The use of axis ranges also implies agreement on the types of axes along which clients could access portions of each type of file. This could omit certain useful axes or result in an inconsistent axis among servers for a particular file type.

### SUMMARY

A media fragmenting system is described herein that allows requesting portions of a content item through information specified in a Uniform Resource Identifier (URI) used to retrieve the content item. Media fragments retrieved using the media fragmenting system are cacheable by existing Internet infrastructure and allow clients to retrieve portions of a content item without retrieving the entire content item. The media fragmenting system adds a content range segment to the URI to specify a portion of the content item. A server receiving the URI accesses the content item, identifies the requested portion, and returns the requested portion in a standard HTTP response to the client. Because no changes to the HTTP protocol are involved, intermediate servers, routers, and proxies, can all handle the request and response as well as cache the response without modification.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the media fragmenting system, in one embodiment.

FIG. 2 is a block diagram that illustrates an operating environment of the media fragmenting system using Microsoft Windows and IIS, in one embodiment.

FIG. 3 is a flow diagram that illustrates the client-side processing of the media fragmenting system, in one embodiment.

FIG. 4 is a flow diagram that illustrates the server-side processing of the media fragmenting system, in one embodiment.

### DETAILED DESCRIPTION

A media fragmenting system is described herein that allows requesting portions of a large, downloadable content item through information specified in a Uniform Resource Identifier (URI) used to identify the location of and retrieve the content item. Media fragments retrieved using the media fragmenting system are cacheable by existing Internet infrastructure and allow clients to retrieve portions of a content item without retrieving the entire content item. As an example, consider a video file accessible using a URI “http://xyz.com/a.wmv.” A request in a web browser or web-based video player to access the URI would typically cause the browser to download the entire file and then begin playing it (or possibly play the file while retrieving the file as the player receives enough information). The media fragmenting system adds a content range segment to the URI (that is understood by a client and server communicating to access a content item) to specify a portion of the content item.

One type of content range provided by the system is time based and provides a start and end location in milliseconds. For example, the URI “http://xyz.com/a.wmv/Slice(st=0,et=10000)” specifies the same content item as the previous example, but indicates that the client wants to retrieve only the first 10 seconds of the video (start time zero, end time 10000 milliseconds). The system may also accept other types of content ranges, such as a different time resolution (e.g., seconds), a different time specification (e.g., (start, duration) rather than (start, stop)), pages in a document, bookmarked portions of a file, content indexes (e.g., advertisement(1), advertisement(2)), and so forth. A server receiving the request accesses the content item, identifies the requested portion, and returns the requested portion in a standard HTTP response to the client. Because no changes to the HTTP protocol are involved, intermediate servers, routers, and proxies, can all handle the request and response as well as cache the response without modification. Thus, the media fragmenting system provides a way of accessing portions of large content that is cacheable and compatible with existing Internet infrastructure.

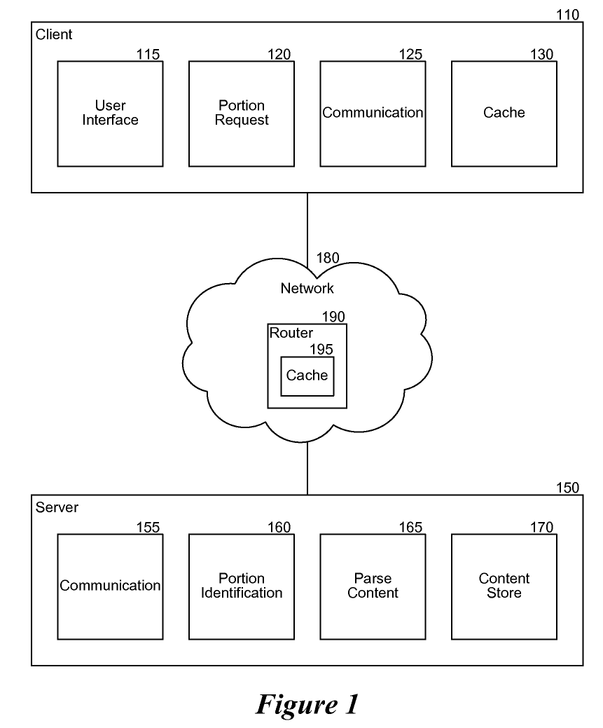

FIG. 1 is a block diagram that illustrates components of the media fragmenting system, in one embodiment. The media fragmenting system includes at least one server that communicates with one or more clients. A typical client 110 includes a user interface component 115, a portion request component 120, a communication component 125, and a cache component 130. A typical server 150 includes a communication component 155, a portion identification component 160, a parse content component 165, and a content store 170. Each of these components is described in further detail herein. A network 180, such as the Internet or a Local Area Network (LAN), connects the client 110 and server 150. The network 180 between the client 110 and server 150 may include any number of routers, proxies, gateways, and other network devices, such as router 190. These devices may include caches, such as the cache 195, that store data from recent requests and provide that data in response to later requests to increase network efficiency. These devices can be tiered as well, so that one cache talks to another cache, that cache talks to the server, and so on.

The user interface component 115 of the client 110 displays a user interface to a user and receives requests to access a portion of a content item from the user. The user interface component 115 may receive requests directly from the user (e.g., in the form of a start and end time) or through controls, such as a user selecting a region along a video timeline. Typically a user specifies a content item (e.g., by providing a URI), and a portion identification (e.g., a start time and an end time) through the user interface.

The portion request component 120 of the client 110 creates segments and adds them to a URI of a content item requested by a user or application to identify the portion of the content that the user or application is interested in retrieving. The portion request component 120 can use a variety of formats so long as the resulting URI is valid. The URI Specification (RFC 3986) defines certain unreserved characters (a-z, A-Z, 9-0, -, _, and ˜) that are valid in a URI, and certain other reserved characters (!, *, ', (, ), ; , : , @, &, =, +, $, comma, /, ?, %, #, [, and ]) that are valid in certain contexts. Reserved characters may be URI encoded (sometimes called percent encoding) to form allowable escaped versions of the characters (e.g., %21 in place of !). The component 120 can even encode characters not allowed in a URI (e.g., space encoded to %20) to allow inclusion. Those of ordinary skill in the art will recognize many combinations of characters not commonly found in content item URIs that the system can use to specify the portion segment.

In addition to appending characters to the URI, the portion request component 120 may also append information to the URI path to create a URI that identifies a portion of a content item. For example, the system can define the URI “http://xyz.com/a.wmv/portion(1,4)” (where 1 and 4 may be seconds or some other units relevant to the file's content) to refer to a portion of the content item that is accessible in full using the URI “http://xyz.com/a.wmv.” The system can also use this format to specify other axes along which a content provider may divide a content item. For example, a video may be accessed by time, using a URI such as “http://xyz.com/a.wmv/time(5000,10000)” (where 5000 and 10000 are, for example, milliseconds of play time in the file) or by previously defined highlight portions using the URI “http://xyz.com/a.wmv/highlight(1).” Note that as shown in the previous example, the system does not always specify a start and end range, but may in some implementations specify only a start, only an end, a page, an identifier, or other useful specification of the portion of interest. As another example, the component may be used to select an audio portion in a particular language from an audio file containing audio portions that are in several human languages using syntax such as “a.wmv/lang(en-us)” (using the W3C-style identifier “en-us” for United States English) or similar. Alternatively or additionally, the component may be used to select different content entirely that is grouped under a single URL. For example, a URL http://xyz.com/music.wmv(country) may select a genre of music among several genres (e.g., country western, classical, rock) for playback.

The communication component 125 of the client 110 sends HTTP requests and receives HTTP responses between the client and one or more servers. Although shown within the system 100, the communication component 125 may be a library (e.g., WinInet) or other Application Programming Interface (API) provided by an operating system or application running on the client external to the media fragmenting system 100.

The client 110 may also include a cache component 130 that stores retrieved content items or portions of content items in case the user makes a subsequent request for the same content item.

The server 150 also contains a communication component 155 similar to the communication component 125 of the client 110 that receives HTTP requests and sends HTTP responses. The server may include a web server application, such as Microsoft Internet Information Services (IIS) or Apache, that directs requests to files stored on the server. Most web servers also allow developers to create extensions to intercept and respond to requests received through the web server. For example, the system may implement the portion identification component described herein as an IIS extension that receives the request URL and extracts the underlying content item and portion from an HTTP request.

The portion identification component 160 of the server 150 receives a URI, parses the URI into segments that identify a content item and one or more portions of the content item, and retrieves the requested content item portions from the content store. For example, the portion identification component 160 may receive a request for the URI “http://xyz.com/a.wmv(10,20),” access the content item “a.wmv” on the hard drive of the web server, identify the portion corresponding to a start time of 10 seconds and a stop time of 20 seconds, and then provide that portion to the communication component to send back to the client as an HTTP response to the client's request.

In some embodiments, the portion identification component 160 may include an extensibility model for adding a content filter that understands a format associated with a particular type of content item and that provides axes along which clients can access portions of the particular type of content item. For example, a PDF content filter may include knowledge of the data structure of a PDF file and axes that include page numbers and bookmarks. When a user installs the content filter on the web server, it extends the web server to allow responding to requests for particular pages or bookmarks of PDF files provided by the web server. As another example, a content filter for videos of baseball games may include axes for selecting a portion of the video associated with a particular inning.

The parse content component 165 of the server 150 loads and opens the content item based on its type to extract requested portions of the content based on the dimensions and/or units of the portion request. For example, if a requested content item is an Motion Picture Experts Group (MPEG) video file and a client requests the portion based on a time range, then the parse content component opens the video file, loads a header of the video file that provides encoding and other information, and identifies the frames of the video that correspond to the specified time range.

The content store 170 is a storage medium that provides volatile or nonvolatile storage for content items. The content store 170 can include a database of content (e.g., for large content providing servers), a file system on a hard drive or Storage Area Network (SAN), an in-memory database (e.g., for content items of low temporal duration), and/or any other type of storage for content items.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

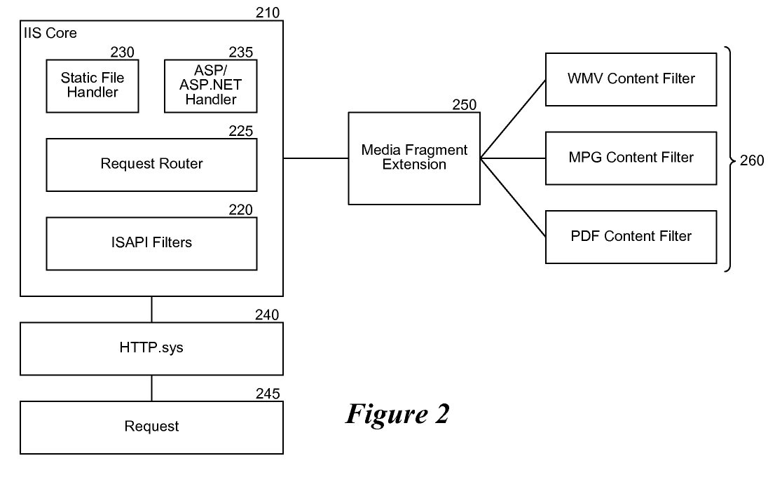

FIG. 2 is a block diagram that illustrates an operating environment of the media fragmenting system using Microsoft Windows and IIS, in one embodiment. An incoming request 245 passes through a kernel-mode driver, http.sys 240 that processes HTTP requests and passes the requests to IIS 210. IIS 210 passes the request to any applicable ISAPI filters 220. The ISAPI filters 220 receive notification at the start of processing a request (a BeginRequest notification) and at the end of processing a request (an EndRequest notification), and can be designed to perform a variety of tasks related to a request 245. In some embodiments, the media fragmenting system interfaces with IIS 210 as an ISAPI filter, shown as the media fragment extension 250. The extension 250 receives notification of incoming requests through the BeginRequest and EndRequest processing notifications and can perform the processing described herein. After notifying any ISAPI filters 220, IS 210 passes the request 245 to a request router 225 that determines an appropriate handler for the request based on the file extension of the requested resource in the IIS 210 Metabase (for IIS 6.0) or other configuration (for IIS 7, e.g., an applicationhost.config or web.config file). If there is no mapping, the request is handled by the static file handler 230 (e.g., for HTML files, images, videos, and Adobe Acrobat (PDF) documents). This concept could be integrated in server-side playlists as well. IIS 210 routes ASP and ASP.NET requests to the ASP handler 235. The extension 250 may also invoke one or more content filters 260, as described further herein, to parse the content of a particular type of content item and provide the requested portion. For example, a PDF content filter may parse a PDF file and respond to requests to deliver specific pages of a PDF document stored in a PDF file. As another example, a WMV or MPG video file content filter may parse a video by reading video header information and seeking within the video based on the header information and a requested time specification. IIS 7 introduced the ability to add modules to the IIS request-handling pipeline and includes ISAPI filters for backwards compatibility. In some embodiments, the media fragmenting system interfaces with IIS 7 using an IIS module instead of an ISAPI filter.

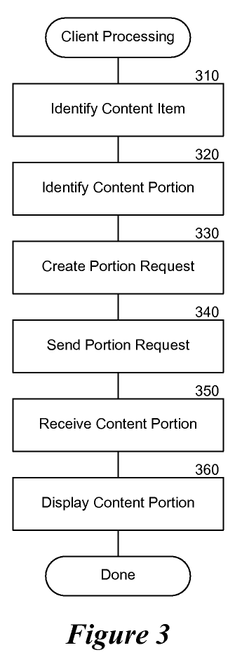

FIG. 3 is a flow diagram that illustrates the client-side processing of the media fragmenting system, in one embodiment. These steps are invoked when a user wants to use a particular portion of a content item. In block 310, the system receives an identification of the content item with which the user wants to interact. For example, the user may identify a video file by clicking on a link in a web browser or typing a URL in a media player application. Continuing in block 320, the system receives an identification of a portion of the content item from the user. For example, the user may click a link that includes a start and end time or select a portion of a video on a timeline. Continuing in block 330, the system creates a content portion request that includes the identification of the content item and the identification of the portion to retrieve. For example, the system may form a URI composed of the URI of the content item and append portion information in a format agreed upon by the client and server.

Continuing in block 340, the system sends the content portion request to the server for processing. For example, the system may submit the request to an HTTP communication layer that forms a standard HTTP GET request for retrieving the content portion and sends the request to the server. Continuing in block 350, the system receives the requested content portion from the server. For example, the system may receive an HTTP 200 response that includes the content portion as data. Continuing in block 360, the system displays the received content portion to the user. For example, the system may play a received audiovisual file in a media player application on the client. After block 360, these steps conclude.

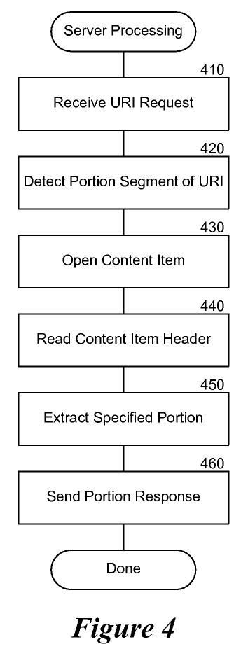

FIG. 4 is a flow diagram that illustrates the server-side processing of the media fragmenting system, in one embodiment. These steps are invoked when the server receives a request from a client to access a particular portion of a content item. In block 410, the system receives a request URI that specifies a portion of a content item. For example, a web server application may invoke the system as an extension of the web server application when the application receives a new HTTP request. Continuing in block 420, the system parses the received request URI to identify the specified portion of the content item. For example, the system may identify an open parenthesis or other defined character that identifies the start of a content portion specification and read the content portion specification. Continuing in block 430, the system opens the content item specified by the URI. For example, the system may access the item from a disk of the server.

Continuing in block 440, the system reads a content item header associated with the content item that describes the organization of the content item. For example, if the content item is an MPG file, then the system accesses the MPG header at the beginning of the opened MPG file. Continuing in block 450, the system extracts the specified content portion from the content item based on information from the content header. For example, if the content portion specification is a time range in a video, then the system uses the header information to identify the frames of the video that correspond to the specified time range. Continuing in block 460, the system sends the specified portion of the content item to the client in response to the received request. For example, the system may send a 200 HTTP response with the content item portion included in one or more associated packets through a communication layer.

In some embodiments, the media fragmenting system includes an application that displays advertisements during playback of a video or other content item. In previous systems, a content provider that wants a user to see advertisements when a client displays content generally modified the content at the server to insert (either dynamically or prior to the request) the advertisements into the video file. Thus, a content provider might take a video of a TV show, show.wmv that is 45 minutes long and insert four different ad segments to make the video one hour long. A client viewing the file sees the show and the advertisements. This is achieved without having four different content items on the server.

With the media fragmenting system, the server can provide the client with a playlist of segments to display and an application on the client can display the content items to the user in a seamless presentation. For example, using the original 45 minute show in the previous example, a playlist might specify playing the first ten minutes of the show “show.wmv(0,600000)” then an advertisement stored within a large advertisement file “ads.wmv(100000,130000)” and then continue playing another ten minutes of the show “show.wmv(600000,1200000).” This reduces the burden on the server caused by editing content items and allows content providers to insert advertisements and other inserted content easily and to rotate the inserted content through a change to the playlist provided to the client. The server can use common Digital Rights Management (DRM) techniques to ensure that the client does not modify the playlist (e.g., to skip the advertisements).

Similarly, in some embodiments, the media fragmenting system provides for the playback of highlights or previews of a content item at the client. For example, a content provider, user forum, or other source may identify the most interesting segments of a football game by time, and provide these segments as media portion request URIs either individually or in a playlist format. For example, several highlights could be found at the URIs “http://xyz.com/football.wmv(12500,50000)” and “http://xyz.com/football.wmv(1000000,1050000).” Clients only request the amount of the video that includes the highlights and the server only responds with those portions, saving bandwidth and time. In addition, if clients request the same portions frequently, clients will benefit from caching and may receive a faster cached response to a request for a portion of a content item.

In some embodiments, the media fragmenting system defines portions based on predefined labels stored at the server. For example, rather than allowing a client to access a video file by time, the system may receive information that the video has five available portions that the client can request (e.g., “http://xyz.com/a.wmv(3)”). The system can use this attribute to prevent the client from skipping sections of the video (such as an advertisement) that the content provider wants the user to view. The system may also use this attribute to reduce the amount of information, such as about what times correspond to what events, that is sent to the client. Instead, the server can instruct the client to play a first portion of a show, then an advertisement, then a second portion of the show, and so on, without the client being aware of how long each portion is beforehand.

In some embodiments, the media fragmenting system conforms to the guidelines of the Representational State Transfer (REST) style of software architecture for distributed hypermedia systems. One concept in REST is that an application can interact with a resource by knowing only the identifier of the resource (e.g., a URI) and the action requested (e.g., retrieval), and without knowing whether there are caches, proxies, gateways, firewalls, tunnels, or anything else between the application and the server actually holding the information. Following REST guidelines allows the system to benefit from existing Internet infrastructure and pre-existing resource conserving techniques such as caching. Some example RESTful principles that the system implements in some embodiments include: each URI identifies exactly one response, each URI points to a server resource that is stateless and cacheable, and each URI is intuitive and uses nouns (verbs are HTTP verbs).

In some embodiments, the server reconstructs the header of a file returned in response to a media fragment request. For example, if the requested content item is a Windows Media Video (WMV) file and the client requests the portion from 10 to 20 seconds into the file, then the server may create a WMV header such that the 10 seconds of video that the server returns to the client in the response is playable by any WMV player. The server may do this by searching for the nearest key frame to the specified time and starting the new video with the identified key frame. This allows the client to handle the file with fewer modifications and allows easier diagnosis of problems with the system, since each item produced is an intact content item in its own right.

In some embodiments, the media fragmenting system provides a method for clients to request header and other content metadata information about a content item from the server. For example, for a video file “a.wmv” the server may reserve the URI “http://xyz.com/a.wmv/info” for returning this type of information. The information may be in an Extensible Markup Language (XML) format or other format understood by the client and may include information such as the length of the content item (in time, frames, or other units), the encoder(s) used to encode it, other associated content to play in association with the content item (e.g., advertisements), a list of highlights, and so forth. This allows the client to request information that may be useful in subsequent requests to retrieve portions of the content item.

In some embodiments, the media fragmenting system switches between multiple quality versions of a content item. For example, if a video file is available in three different encodings (e.g., bitrates) corresponding to low, medium, and high quality, then the media fragmenting system may initially play the request and play a portion of the highest quality encoding. As the client detects congestion, the client may switch to a lower quality encoding that uses less network bandwidth. Over time as congestion clears or the client detects further bandwidth is available, the client may switch to a higher quality encoding. The media fragmenting system facilitates this process by allowing the client to only download the portions of each encoding of the content item that the client is going to use for playback, rather than all of each encoding (which would defeat the purpose of switching encodings to reduce bandwidth).

In some embodiments, the media fragmenting system enforces access control on portion requests. For example, a content provider may allow anonymous users to request a preview portion of a particular content item, but only allow premium, paying users to view other portions or the entire content item. A movie company could construct a dynamic trailer from a movie file by listing portions for the client player to stitch together directly from a content item containing the entire movie, while subscribers may be able to download and play the entire movie file.

In some embodiments, the media fragmenting system provides error handling. It is possible that a client could request a portion of a content item that does not exist, such as a time beyond the end of a video file. In such cases, the media fragmenting system identifies the closest portion that satisfies the client request. For example, the system may ignore an end time that extends beyond the end of the content item if the start time is within the content item's bounds. Alternatively or additionally, the system may respond with the entire content item if a client requests an unrecognized or invalid portion, so that the system behaves as prior systems would in the worst case.

In some embodiments, the media fragmenting system embeds units in the portion request URI. For example, an “s” may specify seconds as in (50s,60s), an “h” hours, and so forth. The system may also accept other familiar formats such as a time specification of the form “5:30” for five minutes, thirty seconds. The system may accept different units based on the type of the content, such as (para.5) for the fifth paragraph of a document or (track.9) for the ninth track of an audio file. Those of ordinary skill in the art will recognize many possible variations of units that the system could receive and handle.

From the foregoing, it will be appreciated that specific embodiments of the media fragmenting system have been described herein for purposes of illustration, but that various modifications may be made without deviating from the spirit and scope of the invention. For example, although content items have been described in terms of items for display to users, the content may also include data for consumption by a web service or other non-interactive requester. Accordingly, the invention is not limited except as by the appended claims.

1. A computer-implemented method for retrieving a portion of a content item from a server, the method comprising:
receiving a Uniform Resource Identifier that specifies a portion of a content item;
parsing the received Uniform Resource Identifier to identify the specified portion of the content item;
opening the content item specified by the Uniform Resource Identifier by accessing the content item from a content store;
reading organizational information associated with the content item that describes an organization of the content item;
extracting the specified content portion from the content item based on information from the organizational information; and
sending the specified portion of the content item to a client in response to the received request,
wherein the preceding steps are performed by at least one processor.

2. The method of claim 1 wherein receiving a Uniform Resource Identifier comprises a web server application on the server invoking an extension of the web server application in response to receiving a new Hypertext Transfer Protocol request.

3. The method of claim 1 wherein parsing the received Uniform Resource Identifier comprises identifying a file associated with the content item, a start time, and an end time.

4. The method of claim 1 wherein extracting the specific content portion comprises identify frames of the video that correspond to a specified time range based on the organizational information.

5. The method of claim 1 wherein the content item is an audiovisual file and the Uniform Resource Identifier specifies a time range of content within the audiovisual file.

6. The method of claim 1 wherein the content item is a document file and the Uniform Resource Identifier specifies a page of the document file.

7. The method of claim 1 wherein extracting the specified content portion comprises matching the received specification of the content portion with a predefined label associated with the portion of the content item.

8. A computer system for providing portions of a content item to clients of a web server, the system comprising:
a processor and memory configured to execute software instructions;
a communication component configured to receive Hypertext Transfer Protocol requests and send Hypertext Transfer Protocol responses;
a content store configured to provide nonvolatile storage for content items;
a portion identification component configured to receive a Uniform Resource Identifier, parse the Uniform Resource Identifier into segments that identify a content item and one or more portions of the content item, and retrieve the requested content item portions from the content store;
a parse content component configured to open the identified content item and extract identified portions of the content item based on a received Uniform Resource Identifier.

9. The system of claim 8 wherein the web server is configured to run Microsoft Internet Information Service (IIS) and the communication component receives requests and sends responses through IIS.

10. The system of claim 8 wherein the portion identification component and parse content component are included in an extension module that is invoked by a web server application in response to receiving an Hypertext Transfer Protocol request.

11. The system of claim 8 wherein the portion identification component is further configured to receive a start time and stop time of the content item and access the content item to retrieve frames corresponding to the received start time and stop time.

12. The system of claim 8 wherein the portion identification component is further configured to include an extensibility model for invoking one or more content filters that understands a format associated with a particular type of content item and that provides axes along which portions of the type of content item can be accessed.

13. The system of claim 8 wherein the parse content component is further configured to enforce access control based on a user associated with the received Uniform Resource Identifier.

14. The system of claim 8 wherein the received Uniform Resource Identifier indicates units for retrieving the identified portions of the content.

15. The system of claim 8 wherein the parse content component is further configured to construct a new item header and prepend the item header to a copy of the identified portions of the content item.

16. A computer-readable storage medium comprising instructions for controlling a computer system to send a request to retrieve a portion of a content item, wherein the instructions, when executed, cause a processor to perform actions comprising:
receiving from a user an identification of a content item with which the user wants to interact;
receiving from the user an identification of a portion of the content item;
creating a content portion request that includes the identification of the content item and the identification of the portion to retrieve;
sending the content portion request to a server for processing;
receiving the requested content portion from the server; and
displaying the received content portion to the user.

17. The medium of claim 16 wherein displaying the received content portion comprises displaying the content portion in a sequence that includes an advertisement in between at least one other content portion.

18. The medium of claim 16 wherein the content portion comprises one or more segments of the content item identified as highlights of the content item.

19. The medium of claim 16 wherein the content portion comprises a preview of the content item.

20. The medium of claim 16 wherein receiving the requested content portion comprises receiving the requested content portion from a cache between the computer system and the server that stored the content item retrieved from the server during a previous request.
